(19) United States
(12) Patent Application Publication
(10) Pub. No.: US 2010/0123822 A1
(43) Pub. Date: May 20, 2010

(54) Method for Converting Between Display Information Scales

(75) Inventor: Yeqing Wang, Horsham, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/271,160

(22) Filed: Nov. 14, 2008

(51) Int. Cl. H04N 7/01

(52) U.S. Cl. 348/445; 348/441; 348/E07.003

(57) ABSTRACT

A device (10) and method for converting display information between graphics scales, e.g., between a 4:3 aspect ratio and a 16:9 aspect ratio. The method includes arcuately converting at least a portion of at least one dimension of display information between an arcuate format and a chordal or subtense format by scaling display information between the length of an arc length of a curve having a first endpoint and a second endpoint and a linear line segment of the arc length of the curve from the first endpoint to the second endpoint. For example, for a circular curve, arcuate conversion occurs between the length of an arc having a first endpoint and a second endpoint and the length of the chord or subtense of the arc from the first endpoint to the second endpoint.

### BACKGROUND OF THE INVENTION

1. Field of the Invention

The invention relates to display information, such as video information and graphics information. More particularly, the invention relates to methods for converting between different display information scales.

2. Description of the Related Art

The aspect ratio and other scale formats used to format display information typically is a numerical expression of the width to height of the display information. Display information includes, e.g., video information and graphics information displayed on a device, such as a television (monitor) or other suitable display device. For standard television graphics, e.g., National Television System Committee (NTSC) graphics, the aspect ratio is 4:3, i.e., a “4” unit width corresponding to a “3” unit height, proportionally, regardless of the actual size of the screen. For wide screen digital television (DTV) formats for high definition television (HDTV) and some standard definition television (SDTV) formats, the aspect ratio is wider: 16:9, i.e., a “16” unit width corresponding to a “9” unit height, proportionally, regardless of the actual size of the screen.

Since there exists display information meant for display on devices with a 4:3 aspect ratio and display information meant for display on devices with a 16:9 aspect ratio, content providers, service providers and others responsible for delivering and/or displaying display information often are faced with the task of providing display information in both (and sometimes additional) aspect ratio formats or converting display information between different aspect ratios or between other different scale formats. Conventional methods for converting display information typically require that a portion of the converted display information be removed or cut off when displayed, or that edges be added to either the top and bottom or to one or both sides of the display. Some conventional conversion methods use linear conversion techniques to fill out the final display window or screen, however such methods introduce linear distortion to the display information.

### BRIEF DESCRIPTION OF THE DRAWINGS

FIG. 1 is a block diagram of a device for use in converting display information between display formats;

FIG. 2 is a simplified diagram showing conversion of display information between an arcuate format and a chordal or subtense format; and

FIG. 3 is another simplified diagram showing conversion of display information between an arcuate format and a chordal or subtense format.

FIG. 4 illustrates an exemplary operation for performing a conversion in accordance with the principles of the invention.

### DETAILED DESCRIPTION

In the following description, like reference numerals indicate like components to enhance the understanding of the display information scaling device and method through the description of the drawings. Also, although specific features, configurations and arrangements are discussed hereinbelow, it should be understood that such specificity is for illustrative purposes only. A person skilled in the relevant art will recognize that other steps, configurations and arrangements are useful without departing from the spirit and scope of the invention.

Referring now to FIG. 1, shown is a block diagram of a display information processing apparatus or device 10 for use in converting display information between various display formats, e.g., from a first display format to one or more other display formats. For purposes of discussion herein, display information includes, e.g., video information and/or graphics information. Also, for purposes of discussion herein, a display format includes any suitable format for displaying display information, e.g., various aspect ratios, such as 4:3 and 16:9 aspect ratios and other aspect ratios.

The processing device 10 can be completely or partially any suitable device or subsystem (or portion thereof) for receiving and/or processing video/graphic signal display information. Such devices include any signal converter or decoder (set-top) box or other suitable computing device or video device, including a residential gateway, an internet protocol (IP), satellite or cable digital video recorder, a computer, or a home media server system. All or a portion of the processing device 10 can be comprised of any suitable structure or arrangement, e.g., one or more integrated circuits.

The processing device 10 includes an input buffer 12, a processor or scaler/converter processing unit 14 coupled to the output of the buffer 12, and a memory or memory unit 15 coupled to the processor 14. Also, the processing device 10 may include an output buffer or memory unit 16 coupled to the output of the processor 14. It should be understood that the processing device 10 includes other components, hardware and software (not shown) that are used for the normal operation of features and functions of the processing device 10 not specifically described herein. Examples of other components include decoders, decrypters and tuners.

The processing device 10 receives display information from an appropriate source (not shown) of display information, e.g., video information and/or graphics information generated locally from a device, such as a set-top box, or remotely from a service provider of video content that includes graphics and/or graphics information. The service provider can be a television service provider (e.g., a national or local television network), a cable television service provider, an Internet content service provider, a satellite broadcast system service provider, or other suitable service provider. The processing device 10 outputs information to an end-user display, which can be any suitable display device, such as a television or computer monitor.

The processor 14 can be completely or partially configured in the form of hardware circuitry and/or other hardware components within a larger device or group of components. Alternatively, the processor 14 can be completely or partially configured in the form of software, e.g., as processing instructions or one or more sets of logic or computer code. In such configuration, the logic or processing instructions typically are stored in a data storage device (e.g., the memory 15), which typically is coupled to the processor 14. Alternatively, the memory 15 can be included as part of the processor 14, although such is not necessary. The processor accesses the necessary instructions from the data storage device and executes the instructions or transfers the instructions to the appropriate location within the processing device 10.

In operation, the processing device 10 receives display information generated or transmitted from the source. The input buffer 12 stores, at least temporarily, all or a portion of the received display information, which has a first scale format. For example, the display information can be display information having a 4:3 aspect ratio or other suitable scale format. The input buffer 12 provides the stored display information to the processor 14 at a rate that allows the processor 14 to suitably process the display information, i.e., convert the display information from the first scale format to a second scale format, e.g., to a 16:9 aspect ratio. The scale format conversion will be discussed in greater detail hereinbelow. The processor 14 outputs the converted display information to the end-user device either directly or, alternatively, via the output buffer 16, at a rate suitable for the end-user display device to receive the display information.

In general, the processor 14 determines or is otherwise made aware of the scale format of the display information it receives. For example, the scale format of the display information can be encoded or otherwise contained in the display information, e.g., in accordance with any suitable transmission standard that is used to transmit display information. As discussed hereinabove, the scale format can be any suitable display information aspect ratio, e.g., a 4:3 aspect ratio, a 16:9 aspect ratio or other aspect ratio.

As will be discussed in greater detail hereinbelow, the processor 14 then arcuately converts the display information from its current (first) scale format to a desired (second) scale format. The amount of arcuate conversion is based on the first or initial scale format of the display information. The amount of arcuate conversion also is based on whether the initial scale format of the display information is being expanded or compressed, and the shape of the curve or arc being used as the basis for the arcuate conversion. Both the shape of the curve being used in the arcuate conversion and whether the display information is being expanded or compressed can be at least partially determined or selected by the end user or, alternatively, can be determined automatically by the processor 14.

The accuracy of the arcuate conversion generally is proportional to the number of defined segments or format zones used by one or more scaling algorithms in converting the display information in the defined format zones from the first scale format to the second scale format, as will be discussed in greater detail hereinbelow. Accuracy associated with arcuate conversion generally refers to the closeness of the arcuate conversion to the theoretically ideal arcuate conversion. The resolution of the arcuate conversion depends greatly on the capability of the hardware and/or software used to perform the arcuate conversion. Such capabilities also will relate to the number of format zones used in the arcuate conversion.

For purposes of discussion herein, the term “arcuate conversion” or “arcuately converting” is understood to represent any process in which format conversion of display information involves converting at least one dimension, e.g., the horizontal dimension, of display information between an arc length of a curve having a first endpoint and a second endpoint and a linear line segment of the arc length of the curve from the first endpoint to the second endpoint. Thus, for a dimension of display information that would fit along, e.g., an arc of a circle from a first endpoint to a second endpoint, arcuate conversion refers to converting the length of that dimension of the display information to the length of the chord or subtense of the arc from the same first endpoint to the same second endpoint. Such arcuate conversion generally involves compressing at least a portion of the display information, as the length of a linear line segment of the arc length of a curve is less than the length of the arc length of the curve.

Similarly, for a dimension of display information that would fit along a linear line segment of the arc length of a curve from a first endpoint to a second endpoint, arcuate conversion refers to converting the length of that dimension of the display information to the length of the n arc length of the curve from the same first endpoint to the same second endpoint. In such case, arcuate conversion generally involves extending or expanding at least a portion of the display information, as the arc length of a curve is greater than the length of a linear line segment of the arc length of a curve. Those of skill in the art will appreciate that the arc minimizes the conversion level at the center of the picture, hence, minimizing the distortion of images at the center. Images which extend outward from the center are scaled to a greater degree in the conversion, hence pushing the majority of any distortion from the conversion to the periphery of the displayed images.

Arcuate conversion also includes defining the dimension of the display information being converted into a number of segments or zones, with the scaling conversion of the zones being different from one another in each half of the dimension of the display information. Also, it should be understood that the curve of the arc length of the curve to which a dimension of the display information would fit does not have to be a circular curve, but can be any suitable curved shape. For example, the curve can be a parabola, an ellipse, or a curve defined by a plurality of linear segments. However, for purposes of explanation hereinbelow, the curve is shown as an arc and the line segment of the arc length of the curve (arc) is the chord or subtense of the arc.

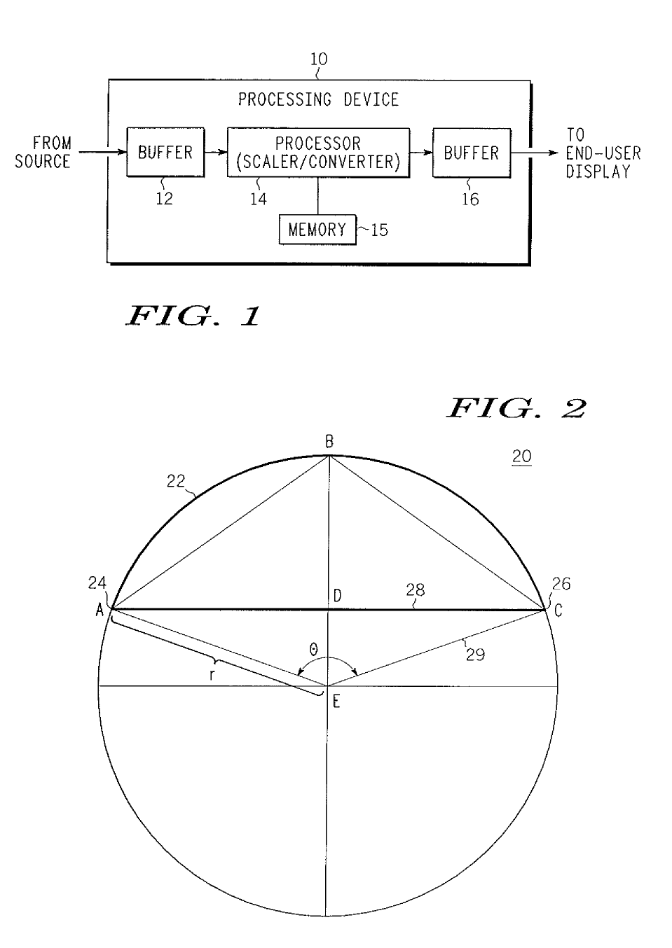

Referring now to FIG. 2, shown is a simplified diagram 20 showing conversion of one dimension, e.g., the horizontal dimension, of display information between an arcuate format and a chordal or subtense format. For purposes of discussion herein, the term “arcuate format” is understood to be a display format of display information in which the length of a dimension of the display information would fit along an arc length of a curve (e.g., an arc) from a first endpoint to a second endpoint. Also, for purposes of discussion herein, the term “chordal format” or “subtense format” is understood to be a display format of display information in which the length of a dimension of the display information would fit along a line segment of an arc length of a curve (e.g., a chord or subtense of an arc) from a first endpoint to a second endpoint.

More specifically, in terms of a circular curve, for display information having an arcuate format, a dimension of the display information has a length that would fit along an arc from a first endpoint to a second endpoint that defines an angle θ subtended by the arc. The length of the arc is r×(θπ/180), where r is the radius of the arc. Similarly, for display information having a chordal or subtense format, a dimension of the display information has a length that would fit along a chord or subtense of an arc from a first endpoint to a second endpoint that defines an angle θ subtended by the arc. The length of the chord or subtense of the arc is 2r×sin(θ/2), where r is the radius of the arc.

In FIG. 2, shown is a circle 20 with an arc 22 having a first endpoint 24 (A) and a second endpoint 26 (C) that defines an angle θ subtended by the arc 22. A chord or subtense 28, i.e., the chord or subtense of the arc 22, also has the first endpoint 24 (A) and the second endpoint 26 (C). The radius r of the arc 22 is defined from the center (E) of the circle 20 to any point on the arc 22, and is shown generally as 29. Although the arc 22 is shown as a circular arc, the arc 22 can be any suitable curved shape, e.g., an ellipse, as discussed hereinabove.

For display information that is to be arcuately converted between an arcuate format and a chordal or subtense format, the arc 22 represents the length of a dimension of the display information, e.g., the horizontal dimension, in the arcuate format. Similarly, the chordal or subtense 28 represents the length of the corresponding dimension of the display information in the chordal or subtense format. For example, for display information that has an x:y format, with x being the width and y being the height of the formatted display information, if the display information is in arcuate format, then the length of the arc 22 from points A to C is equal to x. If the display information is in chordal or subtense format, then the length of the chord or subtense 28 from points A to C is equal to x.

Thus, display information that begins in arcuate format and is arcuately converted to chordal or subtense format is compressed, e.g., horizontally compressed, from the length of the arc 22 to the length of the chord or subtense 28, e.g., using an appropriate scaling algorithm, as the length of the arc 22 is greater than the length of the chord or subtense 28. Similarly, display information that begins in chordal or subtense format and is arcuately converted to arcuate format is expanded or extended, e.g., horizontally, from the length of the chord or subtense 28 to the length of the arc 22, e.g., using an appropriate scaling algorithm.

To convert display information from an arcuate form to a chordal or subtense format using a single or the same scaling algorithm effectively amounts to scaling using linear compression. For example, assume that display information having a plurality of horizontal video lines equal in width to the arc 22 is to be arcuately converted to display information having a plurality of horizontal video lines equal in width to the chord or subtense 28. Using a single scaling algorithm to perform such conversion would involve horizontally compressing each portion of each horizontal video line of the display information by the same amount, i.e., linear compression. As discussed hereinabove, linear conversion methods typically introduce an undesirable amount of distortion.

However, using arcuate conversion, if the horizontal video line or other suitable dimension of the display information is divided into a plurality of format zones, with various format zones scaled differently from the other format zones, e.g., according to different scaling algorithms, the conversion is more accurate and results in less distortion than conventional linear conversion techniques. For example, format zones defined near the center of the display information are converted in a manner that introduces less distortion than conversion of display information in format zones defined near the edges of the display information.

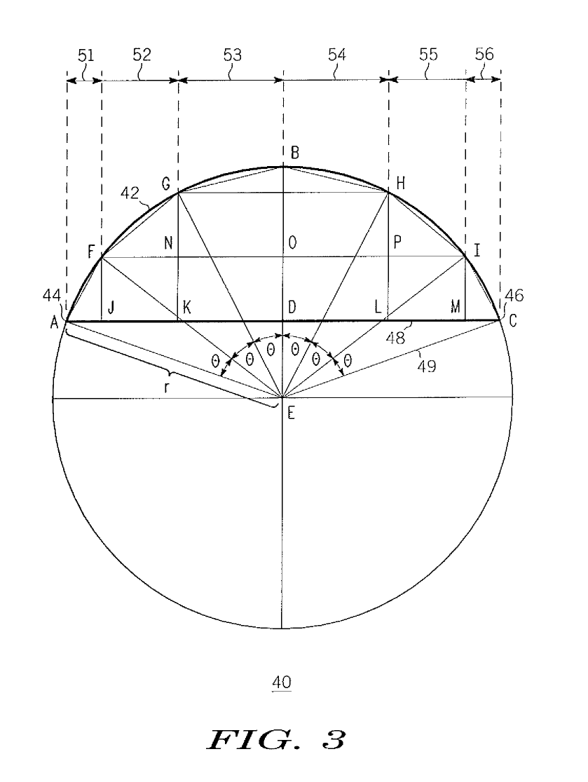

Referring now to FIG. 3, shown is a circle 40 similar to the circle 20 shown in FIG. 2. The circle 40 has an arc 42 with endpoints 44 (A) and 46 (C) that define an angle 6θ subtended by the arc 42. The circle also has a chord or subtense 48, i.e., the chord or subtense of the arc 42, with endpoints 44 (A) and 46 (C). The circle 40 also has a radius r (shown as 49) of the arc 42 defined from the center (E) of the circle 40 to any point on the arc 42.

The circle 40 is divided into a plurality of conversion zones, e.g., six zones: zones 51-56, with each zone defining an angle θ, as shown. Using arcuate conversion, various zones are scaled by a different amount using one or more appropriate scaling algorithms. For example, due to the complementary nature of the arc 42 (and circles in general), zones 51 and 56 can be scaled by a first amount or in a first manner, e.g., using a first scaling algorithm, zones 52 and 55 can be scaled by a second amount or in a second manner, e.g., using a second scaling algorithm, and zones 53 and 54 can be scaled by a third amount or in a third manner, e.g., using a third scaling algorithm. In this manner, using a first scaling amount or algorithm, arcuate conversion in the zone 51 occurs between the portion of the arc 42 from points A to F and the portion of the chord or subtense 48 from points A to J. Similarly, arcuate conversion in the zone 56 occurs between the portion of the arc 42 from points I to C and the portion of the chord or subtense 48 from points M to C.

Similarly, arcuate conversion in the zone 52 occurs between the portion of the arc 42 from points F to G and the portion of the chord or subtense 48 from points J to K. Arcuate conversion in the zone 55 occurs between the portion of the arc 42 from points H to I and the portion of the chord or subtense 48 from points L to M. In keeping with the defined example, a second scaling amount or algorithm would be used to arcuately convert those portions of the arc 42 and the chord or subtense 48 in each of the zones 52 and 55.

Similarly, for the zones 53 and 54, a third scaling amount or algorithm would be used to arcuately convert between the portion of the arc 42 from points G to B and the portion of the chord or subtense 48 from points K to D. Also, the third scaling amount or algorithm would be used to arcuately convert between the portion of the arc 42 from points B to H and the portion of the chord or subtense 48 from points D to L.

Thus, if the display information is being arcuately converted from an arcuate format (arc 42) to a chordal or subtense format (chord or subtense 48), the length of the portion of the dimension of the display information that would fit along the portion of the arc 42 from points I to C is compressed, e.g., horizontally, to the length of the portion of the chord or subtense 48 from points M to C, using the first scaling amount or algorithm. Similarly, the length of the portion of the dimension of the display information that would fit along the portion of the arc 42 from points H to I is compressed, e.g., horizontally, to the length of the portion of the chord or subtense 48 from points L to M, using the second scaling amount or algorithm. In this manner, arcuate conversion occurs in each conversion zone using the appropriate respective scaling amount or algorithm.

Similarly, if the display information is being arcuately converted from a chordal or subtense format (chord or subtense 48) to an arcuate format (arc 42), the length of the portion of the dimension of the display information that would fit along the portion of the chord or subtense 48 from points A to J is expanded or extended, e.g., horizontally, to the length of the portion of the arc 42 from points A to F, using the first scaling amount or algorithm. Similarly, the length of the portion of the dimension of the display information that would fit along the portion of the chord or subtense 48 from points J to K is horizontally extended to the length of the portion of the arc 42 from points F to G, using the second scaling amount or algorithm. In this manner, the length of each chordal or subtense portion, as defined by its respective zone, is expanded to the length of its corresponding arcuate portion in that respective zone using the particular scaling amount or algorithm.

It should be understood that zones 51 and 56 are scaled differently than zones 52 and 55 and differently than zones 53 and 54. Also, zones 52 and 55 are scaled differently than zones 53 and 54. By using a plurality of format zones and different scaling amounts and/or algorithms for arcuately converting between the length of the arc 42 and the length of the chord or subtense 48, the conversion is more accurate than, e.g., linear conversion processes and other conventional conversion processes, at least to the extent that less distortion is introduced. It should be understood that any suitable number of format zones can be defined for purposes of arcuate conversion and any suitable number of scaling algorithms can be used to arcuately convert the defined zones.

Nonetheless, regardless of the number of format zones that are created, in theory, any conversion, including arcuate conversion, will introduce at least some amount of distortion. However, the arcuate conversion as described herein tends to produce a three dimensional (3D) effect that tends to subtly distract the viewer from the distortion that is introduced. Thus, not only does arcuate conversion introduce less distribution than conventional conversion techniques, but also tends to produce an effect than reduces or obscures the effect of the distortion that is introduced.

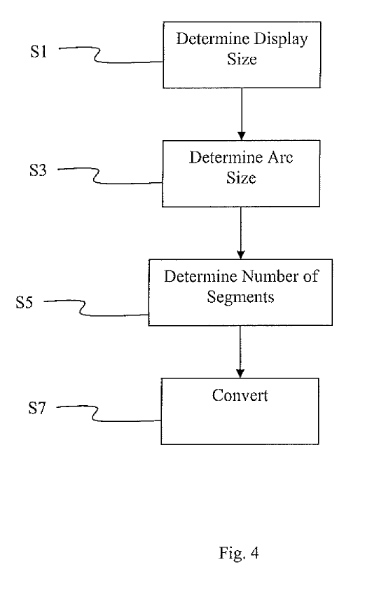

FIG. 4 illustrates an exemplary operation for performing a conversion. As illustrated in FIG. 4, the size of the display is preferably determined (step S1). The display size may be determined from user input in response to a prompt or by receipt of identifying information of the characteristics of the display, such as during an initial connection or set up stage between the display and processing device 10. The arc size may be determined as discussed above in connection with FIGS. 2 and 3 based on display size and the intended display aspect ratio of the received video information (step S3). The intended display aspect ratio of the received video information may predetermined or preprogrammed into processing device, may be determined from information in the video information stream or network providing the video information stream (e.g. program information or a program map table), or may be programmed by a user or technician. The number of arc segments to be used may be determined based on established conversion accuracy levels or based on accuracy levels (or limited distortion levels) which are set according to a user's input (step S5). For example, a conversion from a 4:3 aspect ratio to a 16:9 aspect ration may achieve an acceptable accuracy level using six segments, whereas a conversion to another aspect ratio may use a different number of segments. The process preferably ends with performance of the conversion (step S7).

Although the conversion processes described herein have been described primarily with respect to the horizontal dimension of the display information, it should be understood that such conversion processes also can be performed with respect to the vertical dimension of the display information. Moreover, such conversion processes can be performed on both the horizontal and vertical dimensions of the same display information.

The methods described herein may be implemented in a general, multi-purpose or single purpose processor. Such a processor will execute instructions, either at the assembly, compiled or machine-level, to perform that process. Those instructions can be written by one of ordinary skill in the art following the description herein and stored or transmitted on a computer readable medium. The instructions may also be created using source code or any other known computer-aided design tool. A computer readable tangible medium may be any medium capable of carrying those instructions and may include random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile).

It will be apparent to those skilled in the art that many changes and substitutions can be made to the display information scaling device and method herein described without departing from the spirit and scope of the invention as defined by the appended claims and their full scope of equivalents.

1. A method of converting display information from a first display format to a second display format, comprising:
determining the display format of received display information as the first display format; and
arcuately converting at least a portion of the display information from the first display format to the second display format by scaling at least one dimension of the display information between an arc having a first point and a second point and the chord of the arc from the first point to the second point.

2. The method recited in claim 1, wherein the display information includes a plurality of horizontal video lines, and wherein the instructions for arcuately converting the display information includes scaling at least a portion of the plurality of horizontal video lines between the arc having the first point and the second point and the chord of the arc from the first point to the second point.

3. The method recited in claim 1, wherein the first format further comprises the arcuate format and the second format further comprises the chordal/subtense format, and wherein the instructions for arcuately converting the display information includes instructions for horizontally compressing at least a portion of the display information from the arcuate format to the chordal/subtense format.

4. The method recited in claim 1, wherein the first format further comprises the chordal/subtense format and the second format further comprises the arcuate format, and wherein the instructions for arcuately converting the display information includes instructions for horizontally extending/expanding at least a portion of the display information from the chordal/subtense format to the arcuate format.

5. The method recited in claim 1, wherein display information having the arcuate format includes a horizontal dimension that fits along the surface of an arc from the first point to the second point, and wherein display information having the chordal/subtense format includes a horizontal dimension that fits along the chord of the arc [from the first point to the second point].

6. The method as recited in claim 1, wherein the display information further comprises a plurality of format zones and wherein the instructions for arcuately converting the display information includes scaling the plurality of format zones between the arc having the first point and the second point and the chord of the arc from the first point to the second point using a corresponding plurality of scaling algorithms.

7. The method recited in claim 1, wherein the step for arcuately converting the display information includes instructions for converting at least a portion of at least one dimension of the display information between a length of the arc from the first point to the second point defining an angle θ subtended by the arc and a length of the chord of the arc, wherein the length of the arc is r×(θπ/180) and the length of the chord of the arc is 2r×sin(θ/2), where r is the radius of the arc.

8. The method recited in claim 1, wherein one of the first format and the second format further comprises a 4:3 aspect ratio and the other of the first format and the second format further comprises a 16:9 aspect ratio.

9. A computer-readable medium carrying instructions for a processor to convert display information from a first display format to a second display format, the comprising instructions to perform the steps to perform the steps of:
determining the display format of received display information as the first display format; and
arcuately converting at least a portion of the display information from the first display format to the second display format by scaling at least one dimension of the display information between an arc having a first point and a second point and the chord of the arc from the first point to the second point.

10. The computer readable medium recited in claim 8, wherein the display information includes a plurality of horizontal video lines, and wherein the instructions for arcuately converting the display information includes scaling at least a portion of the plurality of horizontal video lines between the arc having the first point and the second point and the chord of the arc from the first point to the second point.

11. The computer readable medium recited in claim 8, wherein the first format further comprises the arcuate format and the second format further comprises the chordal/subtense format, and wherein the instructions for arcuately converting the display information includes instructions for horizontally compressing at least a portion of the display information from the arcuate format to the chordal/subtense format.

12. The computer readable medium recited in claim 8, wherein the first format further comprises the chordal/subtense format and the second format further comprises the arcuate format, and wherein the instructions for arcuately converting the display information includes instructions for horizontally extending/expanding at least a portion of the display information from the chordal/subtense format to the arcuate format.

13. The computer readable medium recited in claim 8, wherein display information having the arcuate format includes a horizontal dimension that fits along the surface of an arc from the first point to the second point, and wherein display information having the chordal/subtense format includes a horizontal dimension that fits along the chord of the arc [from the first point to the second point].

14. The computer readable medium as recited in claim 8, wherein the display information further comprises a plurality of format zones and wherein the instructions for arcuately converting the display information includes scaling the plurality of format zones between the arc having the first point and the second point and the chord of the arc from the first point to the second point using a corresponding plurality of scaling algorithms.

15. The computer readable medium recited in claim 8, wherein the instructions for arcuately converting the display information includes instructions for converting at least a portion of at least one dimension of the display information between a length of the arc from the first point to the second point defining an angle θ subtended by the arc and a length of the chord of the arc, wherein the length of the arc is r×(θπ/180) and the length of the chord of the arc is 2r×sin(θ/2), where r is the radius of the arc.

16. The computer readable medium recited in claim 8, wherein one of the first format and the second format further comprises a 4:3 aspect ratio and the other of the first format and the second format further comprises a 16:9 aspect ratio.

17. A device for converting display information from a first format to a second format, comprising:
a memory/buffer for storing at least a portion of the display information received by the device; and
a converter coupled to the memory/buffer for arcuately converting at least a portion of the display information from the first display format to the second display format by scaling at least one dimension of the display information between an arc having a first point and a second point and the chord of the arc from the first point to the second point.

18. The device as recited in claim 17, wherein the display information includes a plurality of horizontal video lines, and wherein the converter scales the plurality of horizontal video lines between the arc having the first point and the second point and the chord of the arc from the first point to the second point.

19. The device as recited in claim 17, wherein the first format further comprises the arcuate format and the second format further comprises the chordal/subtense format, and wherein the converter horizontally compresses the display information from the arcuate format to the chordal/subtense format.

20. The device as recited in claim 17, wherein the first format further comprises the chordal/subtense format and the second format further comprises the arcuate format, and wherein the converter horizontally extends/expands the display information from the chordal/subtense format to the arcuate format.

21. The device as recited in claim 17, wherein the converter converts at least one dimension of the display information between a length of the arc from the first point to the second point defining an angle θ subtended by the arc and a length of the chord of the arc, wherein the length of the arc is r×(θπ/180) and the length of the chord of the arc is 2r×sin(θ/2), where r is the radius of the arc.
